(19) United States
(12) Patent Application Publication
(10) Pub. No.: US 2011/0232413 A1
(43) Pub. Date: Sep. 29, 2011

(54) CONNECTING MEMBER AND CONTROL CABLE

(75) Inventors: Yoshikatsu Tsuge, Toyoake-shi (JP); Hiroshi Kimura, Nagoya-shi (JP); Toshio Kuwayama, Toyota-shi (JP)

(73) Assignee: CHUO HATSUJO KABUSHIKI KAISHA, Nagoya-shi (JP)

(21) Appl. No.: 13/050,299

(22) Filed: Mar. 17, 2011

(30) Foreign Application Priority Data
Mar. 23, 2010 (JP) 2010-066679

(51) Int. Cl. F16C 1/14; F16B 7/18

(52) U.S. Cl. 74/502.6; 403/274

(57) ABSTRACT

A connecting member includes a male screw portion, a cable insertion portion, a locking portion, and a crimping portion. The male screw portion is provided at a first end of the connecting member. The cable insertion portion is provided at a second end, opposite to the first end, of the connecting member, and has a closed-bottomed hole into which one end of an inner cable is to be inserted. The locking portion is provided on outer circumference of the connecting member between a bottom of the closed-bottomed hole and the second end, and has a shape which can be caught with a part of an operation object in a circumferential direction of the male screw portion. The crimping portion is provided on the outer circumference between the bottom of the closed-bottomed hole and the second end, and configured to crimp the one end of the inner cable.

### CROSS-REFERENCE TO RELATED APPLICATIONS

This application claims the benefit of Japanese Patent Application No. 2010-066679 filed on Mar. 23, 2010 in the Japan Patent Office, the disclosure of which is incorporated herein by reference.

### BACKGROUND

The present invention relates to a technique of connecting a control cable with a part of an operation object which is installed on a vehicle.

Examined Japanese Utility Model Publication No. H04-018028 discloses a control cable which is provided with a connecting fitting at one end thereof. A pin is attached to the connecting fitting. The pin includes a threaded shaft portion and a rotation stopping member formed adjacent to the threaded shaft portion. The connecting fitting is connected to a control lever in such a manner that a nut is screwed and attached to the threaded shaft portion in a state where the rotation stopping member is inserted into an elongated hole formed in the control lever. In the control cable configured as above, when the nut is screwed and attached to the threaded shaft portion, rotation of the threaded shaft portion is restricted by the rotation stopping member and the elongated hole. Therefore, it is easy to fasten the connecting cable to the control lever by the nut. However, in the control cable as configured above, there is a problem in which it is necessary to separately provide an adjustment mechanism in order to adjust tensile force, etc. of the control cable.

Unexamined Japanese Utility Model Application Publication No. H04-097112 discloses a control cable in which a connecting fitting is provided at one end thereof and a male screw portion is formed on the connecting fitting. In the control cable as above, it is possible to adjust a length of the control cable by rotating a collar which is screwed and attached to the male screw portion. However, in the above control cable, there is a problem in which such an adjustment is cumbersome. This is because, in order to rotate the collar, the collar needs to be removed from a locking portion of a bracket; then, after adjusting the length of the control cable, it is necessary to engage the collar with the locking portion again, so as to facilitate restricting the rotation of the collar.

FIG. 6 shows a control cable 50 as one example of background art by which the problems in the above-mentioned two types of the control cables can be solved. In the control cable 50, a connecting fitting 52 is attached to one end of an inner cable 51 included in the control cable 50. The connecting fitting 52 includes a male screw portion 54 and an engagement portion 56 adjacent to the male screw portion 54. The engagement portion 56 has a closed-bottomed hole 58 formed at an end thereof, which is an opposite side of the male screw portion 54. The closed-bottomed hole 58 extends toward the male screw portion 54. The one end of the inner cable 51 is inserted into the closed-bottomed hole 58. The engagement portion 56 crimps the inserted one end of the inner cable 51 with regard to an entire length of the engagement portion 56. Thereby, the inner cable 51 and the connecting fitting 52 are fastened to each other.

In the control cable 50 as above, as shown in FIGS. 7 and 8A, the engagement portion 56 is inserted into a guide hole 66. The guide hole 66 has a polygonal planar shape formed by a lever member 62 and a bracket 64 attached to the lever member 62 in a parking brake apparatus 60. Then, by rotating a nut member 68 which is screwed and attached to the male screw portion 54, the engagement portion 56 is made to slide within the guide hole 66 so as to adjust a length of the inner cable 51. When the nut member 68 is rotated, an outer wall of the engagement portion 56 is caught with an inner wall of the guide hole 66, thereby restricting rotation of the connecting fitting 52 caused by rotation of the nut member 68. As a result, the nut member 68 can be easily rotated.

### SUMMARY

In the control cable 50, a peripheral shape in a cross section of the engagement portion 56 is made to form a polygonal shape over an entire length thereof, such that the engagement portion 56 can be slidably inserted into the guide hole 66, when the engagement portion 56 crimps the inner cable 51. It is very difficult, however, to accurately form the peripheral shape in the cross section of the engagement portion 56 in the crimping operation. Therefore, for example, if the engagement portion 56 has a small width in a cross section, when the nut member 68 is rotated, the outer wall of the engagement portion 56 is not caught with the inner wall of the guide hole 66, as shown in FIG. 8B. In this case, the engagement portion 56 rotates within the guide hole 66. Therefore, it may cause a problem in which the engagement portion 56 cannot perform a function of restricting the rotation of the connecting fitting 52.

According to one aspect of the present invention, it is desirable to easily achieve restricting rotation of a connecting member which crimps a control cable.

A first aspect of the present invention provides a connecting member that is configured to be attached to one end of an inner cable included in a control cable and to connect the one end of the inner cable to a part of an operation object.

The connecting member includes a male screw portion, a cable insertion portion, a locking portion, and a crimping portion.

The male screw portion is provided at a first end of the connecting member. The cable insertion portion is provided at a second end, opposite to the first end, of the connecting member. The cable insertion portion has a closed-bottomed hole into which the one end of the inner cable is to be inserted. The locking portion is provided on outer circumference of the connecting member between a bottom of the closed-bottomed hole and the second end. The locking portion has a shape which can be caught with the part of the operation object in a circumferential direction of the male screw portion. The crimping portion is provided on the outer circumference of the connecting member between the bottom of the closed-bottomed hole and the second end. The crimping portion is configured to crimp the one end of the inner cable.

A second aspect of the present invention provides a control cable which includes: an outer cable; an inner cable slidably inserted into the outer cable; and a connecting member that is attached to one end of the inner cable and is configured to connect the one end of the inner cable to a part of an operation object.

The connecting member includes a male screw portion, a cable insertion portion, a locking portion, and a crimping portion.

The male screw portion is provided at a first end of the connecting member. The cable insertion portion is provided at a second end, opposite to the first end, of the connecting member. The cable insertion portion has a closed-bottomed hole into which the one end of the inner cable is inserted. The locking portion is provided on outer circumference of the connecting member between a bottom of the closed-bottomed hole and the second end. The locking portion has a shape which can be caught with the part of the operation object in a circumferential direction of the male screw portion. The crimping portion is provided on the outer circumference of the connecting member between the bottom of the closed-bottomed hole and the second end. The crimping portion has a cross section smaller than a cross section of the locking portion. The crimping portion crimps the one end of the inner cable.

In the control cable configured as above, the crimping portion may crimp a portion of the inner cable which is at least 2 mm away from a tip of the one end of the inner cable.

The connecting member may be made of metal.

The locking portion may be formed by one of cold forging and cutting.

The connecting member may have a shaft-like outer shape.

The male screw portion may have a diameter smaller than a diameter of a circle inscribed in the cross section of the locking portion.

The locking portion may be adjacent to the male screw portion, and the crimping portion may be adjacent to the locking portion.

The operation object may be a parking brake apparatus. The part of the operation object may be a lever of the parking brake apparatus and the lever may have a guide hole. In this case, the locking portion may be slidably inserted into the guide hole, and a nut member may be screwed and attached to the male screw portion projecting from the guide hole.

### BRIEF DESCRIPTION OF THE DRAWINGS

The invention will now be described below, by way of example, with reference to the accompanying drawings, in which:

FIG. 1 is a plan view of a control cable according to an embodiment of the present invention;

FIG. 2 is a partial cross-sectional view of the control cable according to the embodiment, showing a main part of the control cable;

FIG. 3 is an enlarged cross sectional view, taken along a-a in FIG. 1;

FIG. 4 is a graph showing a relationship between separation strength and a length B of a portion where crimping is not performed, in the control cable according to the embodiment;

FIG. 5 is a graph showing a comparison of separation strength between the control cable according to the embodiment and a control cable according to background art;

FIG. 6 is a plan view of the control cable according to the background art;

FIG. 7 is a view showing a schematic configuration of a parking brake apparatus using the control cable according to the background art;

FIGS. 8A and 8B are cross sectional views taken along b-b in FIG. 7; FIG. 8A shows a state in which rotation of a connecting fitting is restricted; and FIG. 8B shows a state in which rotation of the connecting fitting is not restricted.

### DETAILED DESCRIPTION OF THE PREFERRED EMBODIMENT

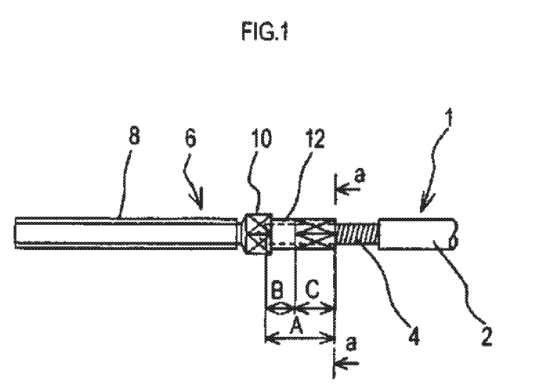

As shown in FIG. 1, a control cable 1 according to the present embodiment is provided with an outer cable 2, an inner cable 4, and a connecting member 6. The inner cable 4 is formed by twisting a plurality of wires together and is slidably inserted into the outer cable 2. The connecting member 6 is attached to one end of the inner cable 4. In the present embodiment, the connecting member 6 as a whole is made of metal; however, the connecting member 6 may be, at least in part, made of materials other than metal.

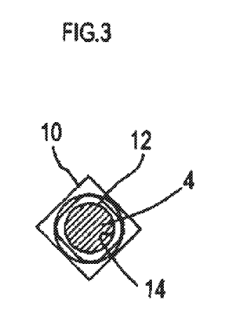

The connecting member 6 has a shaft-like outer shape, and includes a male screw portion 8, a locking portion 10, and a crimping portion 12. The male screw portion 8 is provided at one end of the connecting member 6, and includes a male screw formed on an outer circumference thereof. The locking portion 10 is provided adjacent to the male screw portion 8. In the present embodiment, a peripheral shape in a cross section, taken along a-a in FIG. 1, of the locking portion 10 forms a square (see, FIG. 3); however, the locking portion 10 may be formed having a polygonal shape other than a square shape, such as a triangular shape, a pentagonal shape, a hexagonal shape, a heptagonal shape, an octagonal shape, etc. in the cross-section.

The male screw portion 8 has an outer diameter smaller than a diameter of a circle inscribed in the locking portion 10. It may be possible to provide a small-diameter shaft portion or the like between the male screw portion 8 and the locking portion 10. In this case as well, the small-diameter shaft portion may be configured to have an outer diameter smaller than the diameter of the circle inscribed in the locking portion 10.

The male screw portion 8 may be formed by thread cutting, thread rolling, a die, and the like. The locking portion 10 may be formed by cold forging, cutting, and the like. An external shape of the locking portion 10 may be worked within a normal dimensional tolerance of cold forging or cutting.

The crimping portion 12 is formed adjacent to the locking portion 10. Specifically, in the connecting member 6, the male screw portion 8, the locking portion 10, and the crimping portion 12 are sequentially formed in a direction from one end to the other end of the connecting member 6. The connecting member 6 is provided with a closed-bottomed hole 14 formed at the other end at a side of the crimping portion 12, of the connecting member 6. The closed-bottomed hole 14 extends in an axial direction (a direction from the crimping portion 12 towards the locking portion 10).

The one end of the inner cable 4 is inserted into the closed-bottomed hole 14, thereby fastening the crimping portion 12 and the inner cable 4 together by crimping. After once the inner cable 4 is crimped with the crimping portion 12, the crimping portion 12 is further crimped so that the crimping portion 12 has a cross section smaller than a cross section of the locking portion 10. When the inner cable 4 is crimped, a tip end of the inner cable 4 inserted in the closed-bottomed hole 14 is placed at a portion, of the crimping portion 12, where crimping is not performed and which is closer to a side of the locking portion 10 than a portion where crimping is performed of the crimping portion 12, so as not to crimp the tip end of the inner cable 4 inserted in the closed-bottomed hole 14.

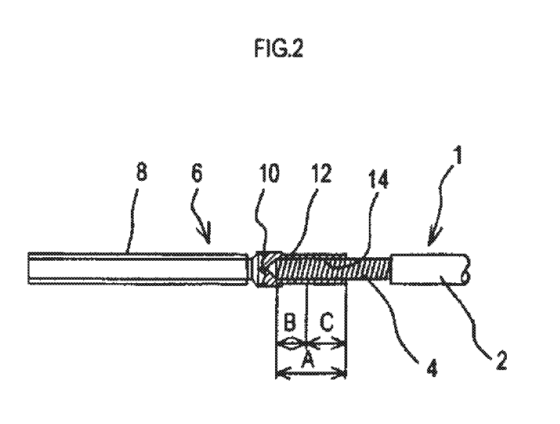

As shown in FIGS. 1 and 2, a symbol “A” refers to a length of a portion, inserted in the closed-bottomed hole 14, of the inner cable 4; a symbol “C” refers to a length of the portion where crimping is performed; and a symbol “B” refers to a length of the portion where crimping is not performed and which is closer to the side of the locking portion 10 than the portion where crimping is performed (i.e., the portion where the tip end of the inner cable 4 inside the closed-bottomed hole 14 is not crimped). In the present embodiment, the crimping is performed with regard to the entire length C including the other end, at the side of the crimping portion 12, of the connecting member 6; however, it may be also possible to have a non-crimped portion having a predetermined length from the other end of the connecting member 6. Moreover, in the present embodiment, there is the portion where crimping is not performed in the crimping portion 12; however, it may be also possible that crimping is performed over the entire length of the crimping portion 12.

The inventors of the present invention have conducted a measurement of separation strength (i.e., strength of resistance to separation) by applying tensile load to the inner cable 4 and the connecting member 6. In this measurement, length C was set 6 mm or 8 mm, and length B was changed from −2 mm to 4 mm by 2 mm increments.

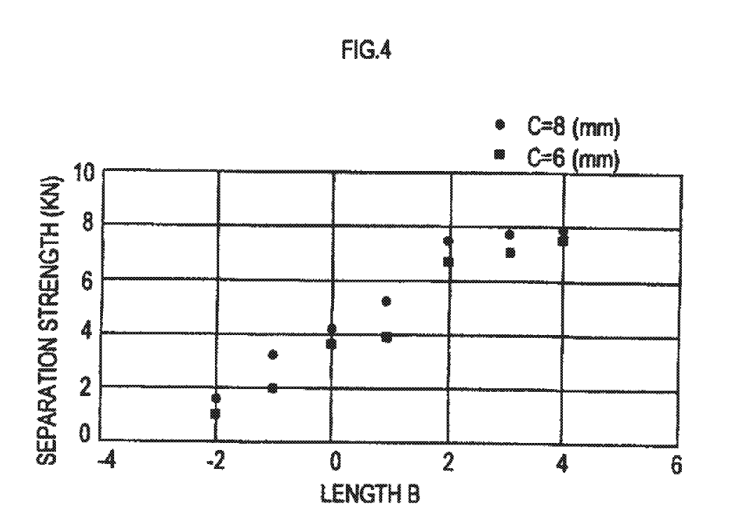

As shown in FIG. 4, significant difference in separation strength was not observed between when length C is 6 mm and when length C is 8 mm. When length B is equal to or less than 0 mm, that is to say, the tip end of the inner cable 4 does not reach the portion where crimping is not performed, separation strength is small, and thus, sufficient separation strength cannot be obtained. When length B is equal to or more than 2 mm, sufficient separation strength can be obtained, regardless of length C. Further, in the case that length B is equal to or more than 2 mm, the separation strength does not significantly change regardless of how long Length B is.

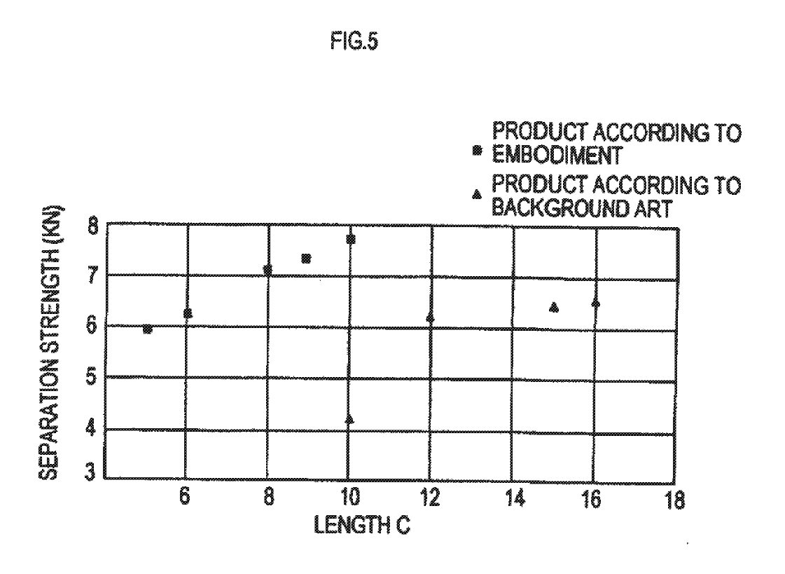

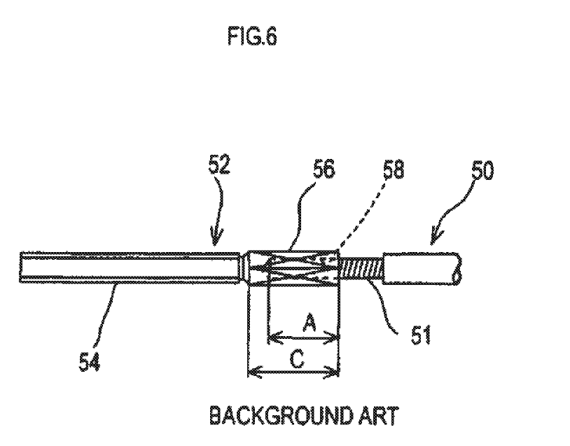

FIG. 5 shows a result of a measurement with regard to separation strength of a product according to the present embodiment and separation strength of a product according to the background art. In the product according to the present embodiment, separation strength was measured with length B set to 2 mm and length C which was changed from 5 mm to 10 mm. In the product according to the background art, as shown in FIG. 6, crimping is performed with regard to an entire length of an engagement portion 56; symbol C refers to a length of a portion where crimping is performed, and symbol A refers to a length of a portion, inserted into a closed-bottomed hole 58, of an inner cable 51. In the product according to the background art, the closed-bottomed hole 58 has a hole depth (i.e., length A of the inner cable 51) smaller than the entire length of the engagement portion 56 (i.e., length C) and crimping is performed with regard to an entire length of the inserted portion of the inner cable 51.

In the product according to the present embodiment, when length C is equal to or more than 5 mm, separation strength equal to or more than 6 KN was obtained. On the other hand, in the product according to the background art, it was necessary to set length C of the engagement portion 56 to 12 mm or more to obtain the same separation strength of 6 KN or more.

As above, in the product according to the present embodiment, when length C is set to 5 mm or more and length B is set to 2 mm or more, separation strength equal to separation strength in the product of the background art can be obtained. Moreover, in the product according to the present embodiment, it is also possible to obtain separation strength equal to separation strength in the product of the background art, even when a total length of the length of the locking portion 10 and the length of the crimping portion 12 is equal to or shorter than the entire length of the engagement portion 56 in the product according to the background art. Accordingly, the connecting member 6 can exhibit separation strength equal to separation strength in the product according to the background art, without making an entire length thereof longer.

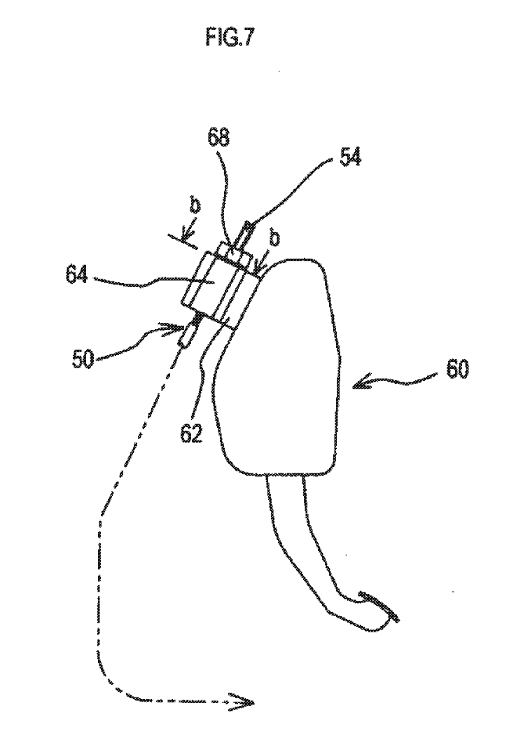

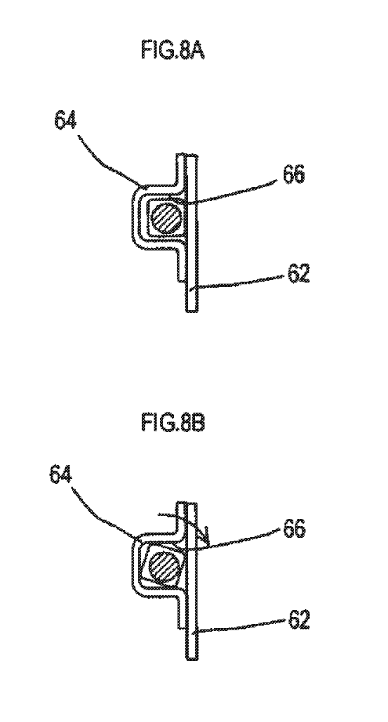

If the control cable 1 of the present embodiment is used, for example, in a parking brake apparatus, the locking portion 10 is inserted into a guide hole 66 formed by a lever member 62 and a bracket 64 attached to the lever member 62, and then a nut member 68 is screwed and attached to the male screw portion 8, in the same manner as in the background art shown in FIGS. 7 and 8A.

The nut member 68 is rotated so as to slide the locking portion 10 within the guide hole 66, thereby adjusting the length of the inner cable 4 and allowing the guide hole 66 to restrict rotation of the locking portion 10. In this case, since the locking portion 10 is formed having an accurate outer dimension, a gap between the locking portion 10 and the guide hole 66 is small, and therefore, the rotation of the locking portion 10 within the guide hole 66 can be restricted.

The present invention should not be limited to the above explained embodiment, and can be practiced in various manners without departing from the scope of the present invention.

What is claimed is:

1. A connecting member that is configured to be attached to one end of an inner cable included in a control cable and to connect the one end of the inner cable to a part of an operation object, the connecting member comprising:
a male screw portion provided at a first end of the connecting member;
a cable insertion portion provided at a second end, opposite to the first end, of the connecting member, and having a closed-bottomed hole into which the one end of the inner cable is to be inserted;
a locking portion provided on outer circumference of the connecting member between a bottom of the closed-bottomed hole and the second end, and having a shape which can be caught with the part of the operation object in a circumferential direction of the male screw portion; and
a crimping portion provided on the outer circumference of the connecting member between the bottom of the closed-bottomed hole and the second end, and configured to crimp the one end of the inner cable.

2. A control cable comprising:
an outer cable;
an inner cable slidably inserted into the outer cable; and
a connecting member that is attached to one end of the inner cable and is configured to connect the one end of the inner cable to a part of an operation object; the connecting member including:
a male screw portion provided at a first end of the connecting member;
a cable insertion portion provided at a second end, opposite to the first end, of the connecting member, and having a closed-bottomed hole into which the one end of the inner cable is inserted;
a locking portion provided on outer circumference of the connecting member between a bottom of the closed-bottomed hole and the second end, and having a shape which can be caught with the part of the operation object in a circumferential direction of the male screw portion; and
a crimping portion having a cross section smaller than a cross section of the locking portion, provided on the outer circumference of the connecting member between the bottom of the closed-bottomed hole and the second end, and crimping the one end of the inner cable.

3. The control cable according to claim 2,
wherein the crimping portion crimps a portion of the inner cable which is at least 2 mm away from a tip of the one end of the inner cable.

4. The control cable according to claim 2, wherein the connecting member is made of metal.

5. The control cable according to claim 4, wherein the locking portion is formed by one of cold forging and cutting.

6. The control cable according to claim 2, wherein the connecting member has a shaft-like outer shape.

7. The control cable according to claim 2, wherein the male screw portion has a diameter smaller than a diameter of a circle inscribed in the cross section of the locking portion.

8. The control cable according to claim 2,
wherein the locking portion is adjacent to the male screw portion, and the crimping portion is adjacent to the locking portion.

9. The control cable according to claim 2,
wherein the operation object is a parking brake apparatus;
wherein the part of the operation object is a lever of the parking brake apparatus, the lever having a guide hole;
wherein the locking portion is slidably inserted into the guide hole; and
wherein a nut member is screwed and attached to the male screw portion projecting from the guide hole.
